(19) United States
(12) Patent Application Publication
(10) Pub. No.: US 2023/0359894 A1
(43) Pub. Date: Nov. 9, 2023

(54) METHODS, APPARATUS, AND ARTICLES OF MANUFACTURE TO RE-PARAMETERIZE MULTIPLE HEAD NETWORKS OF AN ARTIFICIAL INTELLIGENCE MODEL

(71) Applicant: Intel Corporation, Santa Clara, CA (US)

(72) Inventors: Vinnam Kim, Pyeongtaek-si (KR); Wonju Lee, Seongnam-si (KR); Seok-Yong Byun, Seoul (KR)

(21) Appl. No.: 18/312,584

(22) Filed: May 4, 2023

(51) Int. Cl. G06N 3/08

(52) U.S. Cl. CPC G06N 3/08

(57) ABSTRACT

Systems, apparatus, articles of manufacture, and methods are disclosed re-parameterize multiple head networks of an artificial intelligence model. An example apparatus is to train an AI model using labeled data and pseudo-labeled data, the AI model including multiple head networks. Additionally, the example apparatus is to, after the AI model has been trained, re-parameterize the multiple head networks of the AI model into a fully connected layer without re-parameterizing other portions of the AI model.

### FIELD OF THE DISCLOSURE

This disclosure relates generally to artificial intelligence and, more particularly, to methods, apparatus, and articles of manufacture to re-parameterize multiple head networks of an artificial intelligence model.

### BACKGROUND

Machine learning models, such as neural networks, are useful tools that have demonstrated their value solving complex problems regarding object detection, pattern recognition, natural language processing, automatic speech recognition, etc. Neural networks operate, for example, using artificial neurons arranged into layers that process data from an input layer to an output layer, applying weighting values to the data during the processing of the data. Such weighting values are determined during a training process.

### BRIEF DESCRIPTION OF THE DRAWINGS

FIG. 1 is a block diagram of an example environment including example model training circuitry.

FIG. 2 is a block diagram of an example implementation of the model training circuitry of FIG. 1.

FIG. 3 is a block diagram of an example network architecture of an example artificial intelligence (AI) model implemented by the model training circuitry of FIGS. 1 and/or 2 during training.

FIG. 4 is a flow diagram illustrating example structural reparameterization implemented by the model training circuitry of FIGS. 1 and/or 2.

FIG. 5A illustrates an example first graphical illustration depicting example pseudo-label distribution achieved when training models according to examples disclosed herein as compared to other techniques.

FIG. 5B illustrates an example second graphical illustration depicting example pseudo-label distribution achieved when training models according to examples disclosed herein as compared to other techniques.

FIG. 6 is a flowchart representative of example machine readable instructions and/or example operations that may be executed, instantiated, and/or performed by example programmable circuitry to implement the model training circuitry of FIGS. 1 and/or 2.

FIG. 7 is a flowchart representative of example machine readable instructions and/or example operations that may be executed, instantiated, and/or performed by example programmable circuitry to implement the model training circuitry of FIGS. 1 and/or 2 to perform structural reparameterization.

FIG. 8 is a block diagram of an example processing platform including programmable circuitry structured to execute, instantiate, and/or perform the example machine readable instructions and/or perform the example operations of FIGS. 6 and/or 7 to implement the model training circuitry of FIGS. 1 and/or 2.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example

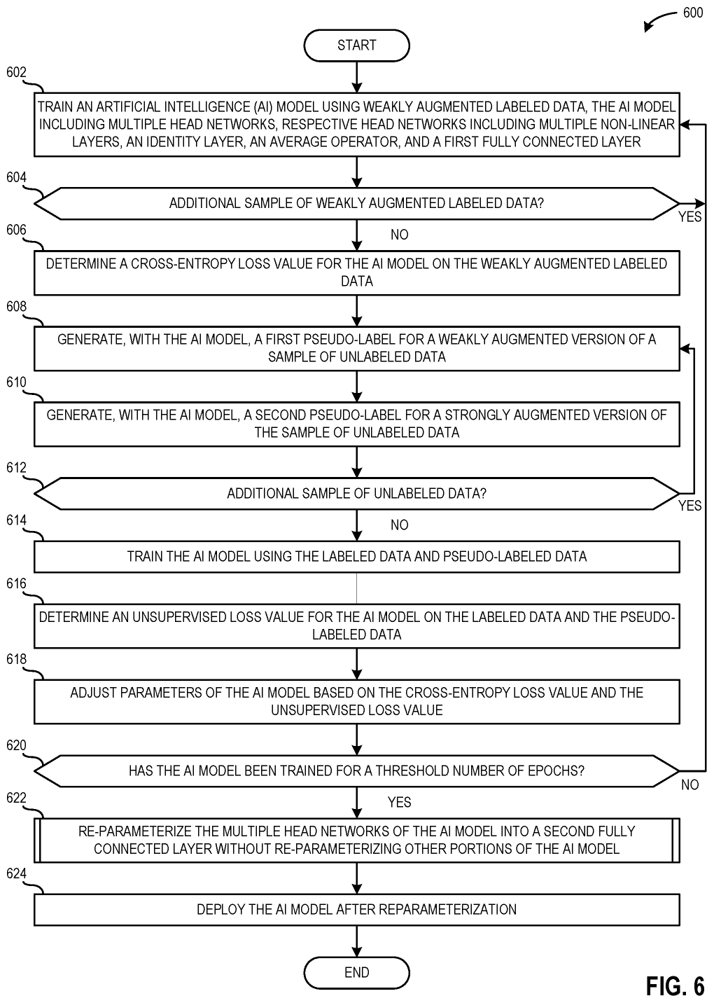

software/firmware/instructions distribution platform (e.g., one or more servers) to distribute software, instructions, and/or firmware (e.g., corresponding to the example machine readable instructions of FIGS. 6 and/or 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations. In general, implementing a ML/AI system involves two phases, a learning/training phase and an inference phase.

In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). In supervised training, labels are generally applied to data by a human. Despite the ease of collecting large amounts of data, research on unsupervised training is being actively conducted because of the large burden involved with labeling data. Unsupervised training (e.g., used in deep learning, a subset of machine learning, etc.) involves inferring patterns from inputs to select parameters for the ML/AI model (e.g., without the benefit of expected (e.g., labeled) outputs).

In some examples, semi-supervised training may be performed. Semi-supervised training, also referred to as semi-supervised learning (SSL), combines pretraining an ML/AI model and finetuning the ML/AI model into a single training pipeline. SSL involves utilizing a large amount of unlabeled data and a small amount of labeled data (compared to the unlabeled data) together to select parameters for an ML/AI model. As such, SSL is favored by AI practitioners because ML/AI models trained via SSL can produce accurate results with less computationally intensive training compared to unsupervised learning while also avoiding as large of a labeling burden as supervised training (e.g., since less labeled data is utilized in SLL).

One technique to perform SSL is referred to as pseudo-labeling. Pseudo-labeling involves generating an artificial label for unlabeled data. To generate artificial labels for the large amount of unlabeled data used in SSL, an ML/AI model is trained using a small amount of labeled data and then used to classify the unlabeled data. These classifications are captured and assigned to the unlabeled data as artificial labels for the unlabeled data. Such artificial labels may be referred to as pseudo-labels. Subsequently, the pseudo-labeled data and the labeled data can be used together to train (e.g., retrain, further train, etc.) the ML/AI model.

Another technique to perform SSL is referred to as consistency regularization. Consistency regularization involves utilizing unlabeled data to find a manifold (e.g., pattern) to which the training dataset subscribes. For example, consistency regularization involves reducing the loss (e.g., difference) between training data and perturbed (e.g., augmented) training data. Consistency regularization is predicated on the idea that realistic perturbations to input data should not change the classification generated by an ML/AI model. Consistency regularization can utilize a weakly augmented version (e.g., a small adjustment relative to an original image) of unlabeled data and a strongly augmented version (e.g., a large adjustment relative to the original image) of the unlabeled data. Weak augmentations of unlabeled data may be imperceptible to humans whereas strong augmentations of unlabeled data may be more perceptible.

Modern ML/AI models (e.g., neural networks) suffer from an over-confidence characteristic. As such, in SSL, modern ML/AI models exclude correct pseudo-labels during early training (e.g., during the first several epochs of training) or include incorrect pseudo-labels during later training (e.g., during the later several epochs) when the ML/AI models are matured (e.g., more fully trained). Examples disclosed herein introduce apre-hoc calibration method for SSL that leverages ensembles only at the head portion of a network to resolve the over-confidence characteristic of modern ML/AI models. Techniques to solve the over-confidence characteristic can be categorized as pre-hoc and post-hoc calibrations of predictive uncertainty. As used herein, pre-hoc calibration refers to calibration of the predictive uncertainty of an ML/AI model by the ML/AI model. As used herein, post-hoc calibration refers to post-processing of the predictive uncertainty of an ML/AI model by an external calibrator.

In ML/AI applications, a model may be represented as a head network and a backbone network. A backbone network refers to the portion of a network that extracts features from an input sample and encodes the features into a feature vector. A head network refers to the portion of a network that determines an output of the network. For example, a head network may be a classification head network responsible for classifying an input sample. Another example of a head network is a regression head network which may be responsible for modeling an input dataset. Yet another example of a head network is a prediction head network which may be responsible for predicting an output (e.g., a next event, a next sample, etc.) given an input sample.

In ML/AI applications, ensembling refers to implementing multiple instances of at least some portions of a network and utilizing some combination of the outputs of the multiple instances to generate an output for the network. For example, ensembling may be implemented at the layer level, where multiple instances of each layer of a network are trained. In examples disclosed herein, by exploiting ensembles at the head portion of a network (e.g., exclusively at the head portion and not at the backbone portion), disclosed methods, apparatus, and articles of manufacture maintain nearly the same computational cost during training as a traditional network. Furthermore, to avoid architectural changes when employing ensembles, examples disclosed herein incorporate structural reparameterization, which allows models that incorporate complex non-linear topology during the training phase to be restructured (e.g., into a single fully connected (FC) layer) during the inference phase. For example, structural reparameterization utilizes different model architectures at training and inference time while maintaining computational equivalence. Example structural reparameterization disclosed herein not only improves performance with non-linear operators during training but also prevents additional overhead through an equivalent transformation during deployment.

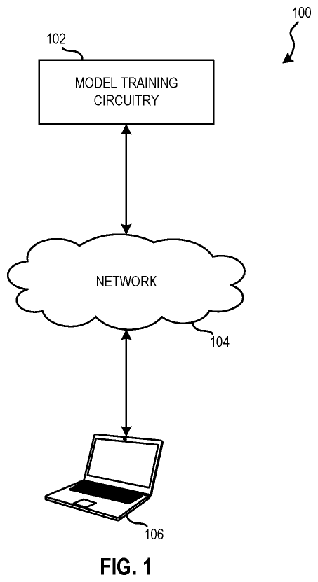

FIG. 1 is a block diagram of an example environment 100 including example model training circuitry 102. The example environment 100 includes the example model training circuitry 102, an example network 104, and an example endpoint device 106. In the example of FIG. 1, the example model training circuitry 102, the example endpoint device 106, and/or one or more additional devices are communicatively coupled via the example network 104.

In the illustrated example of FIG. 1, the model training circuitry 102 is implemented by programmable circuitry in combination with machine readable instructions (e.g., firmware or software). In additional or alternative examples, the model training circuitry 102 is implemented by programmable circuitry in combination with machine readable instructions (e.g., firmware or software), processor circuitry, analog circuit(s), digital circuit(s), logic circuit(s), programmable processor(s), programmable microcontroller(s), graphics processor unit(s) (GPU(s)), digital signal processor(s) (DSP(s)), ASIC(s), programmable logic device(s) (PLD(s)), and/or field programmable logic device(s) (FPLD(s)) such as FPGAs. In the example of FIG. 1, the model training circuitry 102 trains AI models including multiple head networks. For example, an AI model includes a backbone network and multiple head networks.

In the illustrated example of FIG. 1, the model training circuitry 102 combines consistency regularization and pseudo-labeling to improve SSL training of AI models. Additionally, the model training circuitry 102 implements structural reparameterization to train AI models. For example, to train an AI model, the model training circuitry 102 implements respective head networks of the AI model as multiple non-linear layers (e.g., a fully connected (FC) layer and batch-normalization (BN) layer) and an identity layer. Subsequently, before deploying the AI model, the model training circuitry 102 re-parameterizes the multiple head networks of the AI model into a single FC layer without re-parameterizing other portions (e.g., the backbone network) of the AI model. Additional details of the model training circuitry 102 is discussed further herein.

In the illustrated example of FIG. 1, the model training circuitry 102 offers one or more services and/or products to endpoint devices. For example, the model training circuitry 102 provides one or more trained models for download, hosts a web-interface, among others. For example, if the model training circuitry 102 hosts a web-interface, a user operating the endpoint device 106 may a trained AI model. In some examples, the model training circuitry 102 provides endpoint devices with a plugin that implements the model training circuitry 102. In this manner, endpoint devices can implement the model training circuitry 102 locally (e.g., at the endpoint device 106).

In the illustrated example of FIG. 1, the network 104 is the Internet. However, the example network 104 may be implemented using any suitable wired and/or wireless network(s) including, for example, one or more data buses, one or more Local Area Networks (LANs), one or more wireless LANs, one or more cellular networks, one or more private networks, one or more public networks, etc. In additional or alternative examples, the network 104 is an enterprise network (e.g., within businesses, corporations, etc.), a home network, among others. The example network 104 enables the model training circuitry 102 and/or the endpoint device 106 to communicate.

In the illustrated example of FIG. 1, the endpoint device 106 is implemented by a laptop computer. In additional or alternative examples, the endpoint device 106 can be implemented by a mobile phone, a tablet computer, a desktop computer, a server, among others, including programmable circuitry in combination with machine readable instructions (e.g., firmware or software), processor circuitry, analog circuit(s), digital circuit(s), logic circuit(s), programmable processor(s), programmable microcontroller(s), GPU(s), DSP(s), ASIC(s), PLD(s), and/or FPLD(s) such as FPGAs. The endpoint device 106 can additionally or alternatively be implemented by a CPU, an accelerator, a heterogeneous system, among others.

In the illustrated example of FIG. 1, the endpoint device 106 subscribes to and/or otherwise purchases a product and/or service from the model training circuitry 102 to access one or more machine learning models that have been re-parameterized after being trained via a combination of consistency regularization and pseudo-labeling. For example, the endpoint device 106 accesses the one or more trained models by downloading the one or more models from the model training circuitry 102, downloading one or more executable files from the model training circuitry 102, accessing a web-interface hosted by the model training circuitry 102 and/or another device, among other techniques. In some examples, the endpoint device 106 installs one or more plugins to implement a machine learning application and/or other process. In such an example, the one or more plugins implement at least the model training circuitry 102.

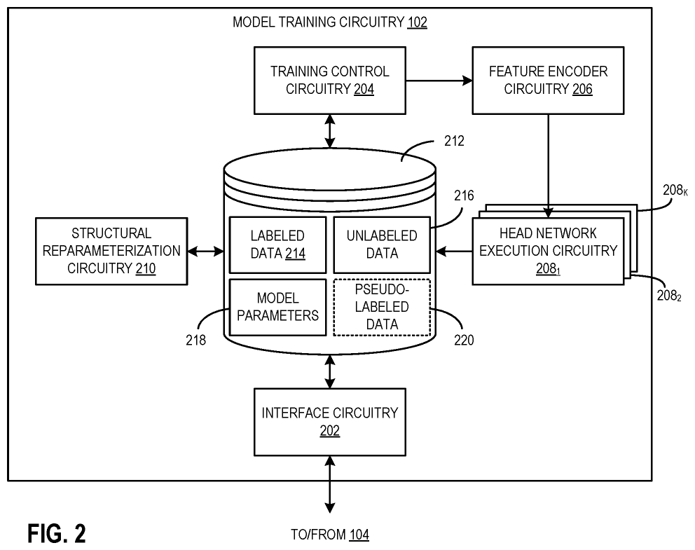

FIG. 2 is a block diagram of an example implementation of the model training circuitry 102 of FIG. 1 to do training one or more AI models to reduce the over-confidence characteristic of AI models. The model training circuitry 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the model training circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the illustrated example of FIG. 2, the model training circuitry 102 includes example interface circuitry 202, example training control circuitry 204, example feature encoder circuitry 206, example head network execution circuitry 208₁-208_{K}, example structural reparameterization circuitry 210, and an example datastore 212. In the example of FIG. 2, the datastore 212 includes example labeled data 214, example unlabeled data 216, and example model parameters 218. In some examples, the datastore 212 includes example pseudo-labeled data 220.

In the illustrated example of FIG. 2, the interface circuitry 202 is coupled to the network 104 of FIG. 1 and the datastore 212. In the example of FIG. 2, the interface circuitry 202 interfaces with the network 104 of FIG. 1. For example, the interface circuitry 202 accesses a request from the endpoint device 106 for a trained AI model. Subsequent to the training control circuitry 204, the feature encoder circuitry 206, the head network execution circuitry 208₁-208_{K}, and/or the structural reparameterization circuitry 210 training an AI model, the interface circuitry 202 deploys (e.g., causes transmission of) the AI model to the endpoint device 106.

In some examples, the interface circuitry 202 accesses the labeled data 214 from publicly available datasets. In additional or alternative examples, a developer of the AI model(s) trained by the model training circuitry 102 may generate the labeled data 214. In some examples, the interface circuitry 202 accesses the unlabeled data 216 from publicly available datasets. In additional or alternative examples, the interface circuitry 202 accesses the unlabeled data 216 from a camera and/or image sensor in communication with the model training circuitry 102. Example publicly available datasets include the CIFAR-10 dataset, the CIFAR-90-M dataset, the CIFAR-100 dataset, the ImageNet dataset, the Tiny-ImageNet dataset, the SVHN dataset, the STL10 dataset, the Euro-SAT dataset, the Euro-SAT-9-M dataset, the Tissue MNIST dataset, and the Semi-Ayes dataset. In some examples, the interface circuitry 202 is instantiated by programmable circuitry executing interfacing instructions and/or configured to perform operations such as those represented by the flowchart(s) of FIG. 6.

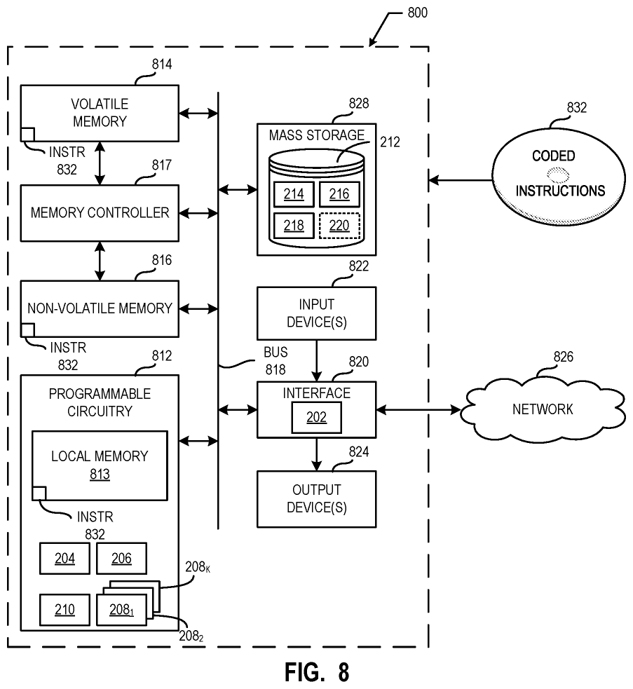

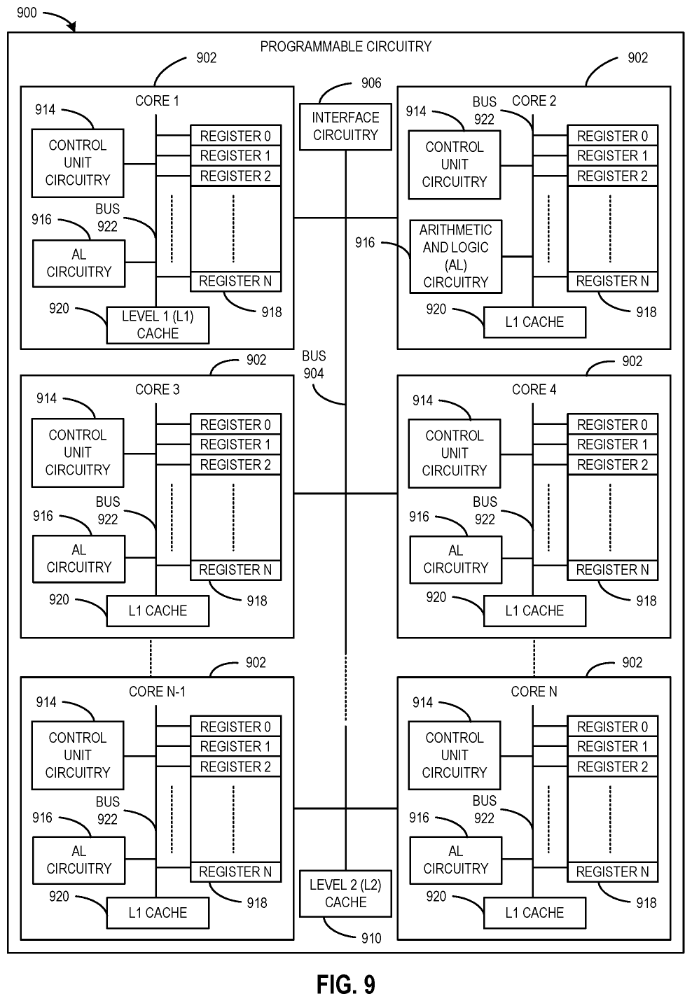

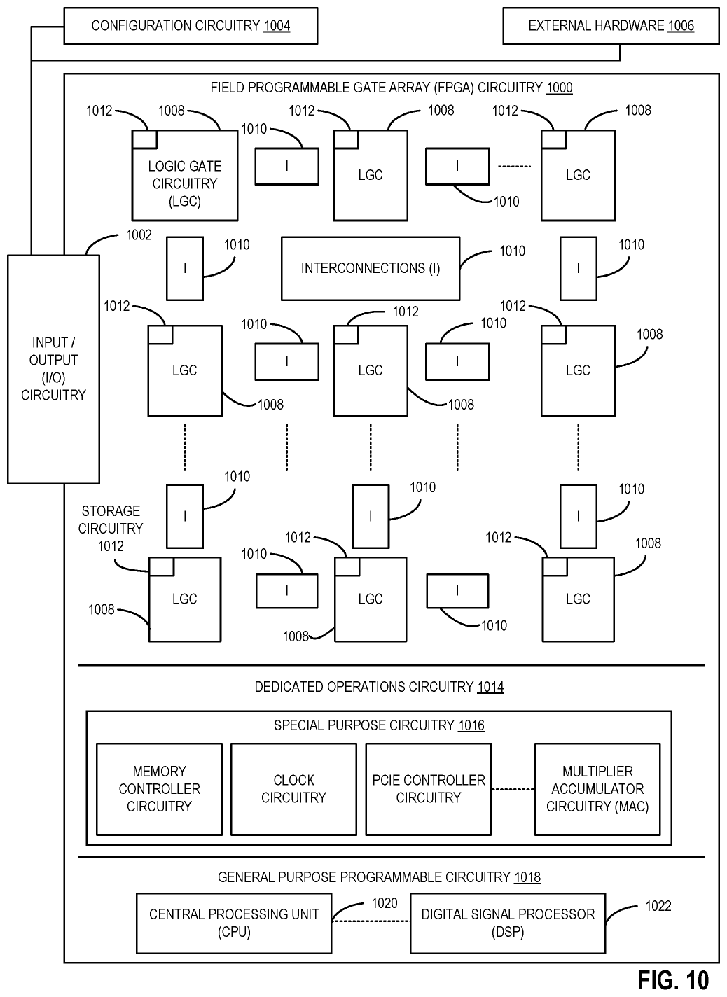

In some examples, the model training circuitry 102 includes means for interfacing. For example, the means for interfacing may be implemented by the interface circuitry 202. In some examples, the interface circuitry 202 may be instantiated by programmable circuitry such as the example programmable circuitry 812 of FIG. 8. For instance, the interface circuitry 202 may be instantiated by the example microprocessor 900 of FIG. 9 executing machine executable instructions such as those implemented by at least block 624 of FIG. 6. In some examples, the interface circuitry 202 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the interface circuitry 202 may be instantiated by any other combination of hardware, software, and/or firmware. For example, the interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 2, the training control circuitry 204 is coupled to the datastore 212 and the feature encoder circuitry 206. The example training control circuitry 204 of FIG. 2 controls training of AI model(s). In the example of FIG. 2, an example AI model trained by the model training circuitry 102 includes a backbone network and multiple head networks. For example, the feature encoder circuitry 206 implements the backbone network. Additionally, for example, the head network execution circuitry 208₁-208_{K} implement the multiple head networks. In some examples, the multiple head networks are referred to collectively as an ensemble head.

In the illustrated example of FIG. 2, the training control circuitry 204 implements SSL to train AI model(s). As described above, SSL involves utilizing a large amount of unlabeled data and a small amount of labeled data (compared to the unlabeled data) together to train an AI model. In the example of FIG. 2, in an example first training phase, the training control circuitry 204 controls operation of the feature encoder circuitry 206 and the head network execution circuitry 208₁-208_{K}, to train an AI model using weakly augmented labeled data. For example, during the first training phase, the AI model (e.g., the feature encoder circuitry 206 and the head network execution circuitry 208₁-208_{K}) processes weakly augmented labeled data (e.g., the feature encoder circuitry 206 and the head network execution circuitry 208₁-208_{K} process weakly augmented labeled data). To generate a weakly augmented version of a sample of the labeled data 214, the training control circuitry 204 preprocesses the sample of the labeled data 214 to make a small adjustment to the sample relative to the original version of the sample of the labeled data 214.

In the example first training phase, after an AI model has processed the weakly augmented version(s) of the labeled data 214, the training control circuitry 204 computes a loss value for the AI model according to Equation 1 below.

$${l}_{s} = \frac{1}{B K} {\sum }_{b = 1}^{B} {\sum }_{k = 1}^{K} H ( {y}_{b} , {p}_{w}^{k} ( {x}_{b} ) ) \qquad Equation 1$$

Equation 1 is an example of a cross-entropy loss function. When implementing Equation 1, the training control circuitry 204 computes a cross-entropy loss value, Iₛ, by summing the cross-entropy loss, H, for each head network, k, over a batch of the labeled data 214. By implementing example Equation 1, the training control circuitry 204 maintains consistency regularization by minimizing the distance between two output distributions that come from weak and strong augmentation pairs of the same sample. In the example of Equation 1, there are K head networks in an AI model (e.g., k=[1, K]) and a batch of the labeled data 214 includes B samples (e.g., b=[1, B]). In the example of Equation 1, x_{b}, represents a sample of the labeled data 214, y_{b} represents a label for a sample of the labeled data 214, and p_{w}^{k}(x_{b}) represents the output of a head network, k, for a weakly augmented (w) sample, x_{b}, of the labeled data 214. In examples disclosed herein, p_{w}^{k}(x_{b}) is implemented according to Equation 2 below.

p_{w}^{k}(x_{b})=SoftMax(h_{w}^{k}(x_{b})) Equation 2

In the example of Equation 2, SoftMax represents the softmax function which takes an input vector of N real numbers and normalizes the input vector into a probability distribution of N probabilities proportional to the exponentials of the input numbers. In the example of Equation 2, h_{w}^{k}(x_{b}) represents the vector output of a head network, k, for a weakly augmented (w) sample, x_{b}, of the labeled data 214. In the example of Equation 2, h_{w}^{k}(x_{b}) can be defined as h_{w}^{k}(x_{b})=f^{k}((g(T_{w}(x_{b})))) where f^{k}( ) represents a head network, g( ) represents a feature encoder, and T_{w}( ) represents a weak augmentation operator.

In the illustrated example of FIG. 2, after the first training phase, the training control circuitry 204 utilizes the AI model to generate pseudo-labels for weakly augmented unlabeled data and strongly augmented unlabeled data. For example, in the second training phase, the training control circuitry 204 controls operation of the feature encoder circuitry 206 and the head network execution circuitry 208₁-208_{K}, to generate classifications (e.g., pseudo-labels) for weakly augmented unlabeled data and strongly augmented unlabeled data. In this manner, the AI model (e.g., the head network execution circuitry 208₁-208_{K}) generates the pseudo-labeled data 220. To generate a weakly augmented version of a sample of the unlabeled data 216, the training control circuitry 204 preprocesses the sample to make a small adjustment to the sample relative to the original version of the sample of the unlabeled data 216. To generate a strongly augmented version of a sample of the unlabeled data 216, the training control circuitry 204 preprocesses the sample to make a large adjustment to the sample relative to the original version of the sample of the unlabeled data 216.

In the illustrated example of FIG. 2, during an example second training phase, the training control circuitry 204 controls an AI model to process the labeled data 214 and the pseudo-labeled data 220. In the example second training phase, after an AI model has processed the labeled data 214 and the pseudo-labeled data 220, the training control circuitry 204 computes a loss value for the AI model according to Equation 3 below.

$${l}_{u} = \frac{1}{μ B K} {\sum }_{b = 1}^{μ B} {\sum }_{k = 1}^{K} 𝟙 ( max ( {q}_{w} ( {u}_{b} ) ) > τ ) \times H ( {\hat{q}}_{w} ( {u}_{b} ) , {p}_{s}^{k} ( {u}_{b} ) ) \qquad Equation 3$$

Equation 3 is an example of an unsupervised loss function. When implementing Equation 3, the training control circuitry 204 computes an unsupervised loss value, lᵤ, by summing the cross-entropy loss, H, for each head network, k, over a batch of the unlabeled data 216 when the predictive uncertainty of a pseudo-label is below a threshold (e.g., the probability associated with a classification of the AI model is greater than a threshold). By implementing example Equation 3, the training control circuitry 204 encourages an AI model to confidently classify unlabeled data (e.g., classify unlabeled data with a high probability value).

In the example of Equation 3, p represents a ratio of the unlabeled data 216 to the labeled data 214, q_{w}(u_{b}) represents a logit vector generated by a head network, k, for a weakly augmented (w) sample, u_{b}, of the unlabeled data 216, \hat{q}_{w}(u_{b}) represents a pseudo-label for the weakly augmented (w) sample, u_{b}, of the unlabeled data 216, and pₛ^{k}(u_{b}) represents the output of a head network, k, for a strongly augmented (s) sample, u_{b}, of the unlabeled data 216. Additionally, in the example of Equation 3,1 [symbol] ( ) represents an indicator function that indicates that the cross-entropy loss, H, should be computed when the maximum value of the logit vector, q_{w}(u_{b}), satisfies (e.g., is greater than) a threshold value. In examples disclosed herein, q_{w}(u_{b}) is implemented according to Equation 4 below.

$${q}_{w} ( {u}_{b} ) = SoftMax ( \frac{1}{K} {\sum }_{k = 1}^{K} {h}_{w}^{k} ( {u}_{b} ) ) \qquad Equation 4$$

In the example of Equation 4, h_{w}^{k}(u_{b}) represents the vector output of a head network, k, for a weakly augmented (w) sample, u_{b}, of the unlabeled data 216. In the example of Equation 2, h_{w}^{k}(u_{b}) can be defined as h_{w}^{k}=f^{k}((g(T_{w}(u_{b})))) where f^{k}( ) represents a head network, go represents a feature encoder, and T_{w}( ) represents a weak augmentation operator. In examples disclosed herein, \hat{q}_{w}(u_{b}) is implemented according to Equation 5 below.

\hat{q}_{w}(u_{b})=argmax(q_{w}(u_{b})) Equation 5

In the example of Equation 5, argmax represents the argmax function which outputs the argument(s) that provide the maximum value of an input function. In examples disclosed herein, pₛ^{k}(u_{b}) is implemented according to Equation 6 below.

pₛ^{k}(u_{b})=SoftMax(hₛ^{k}(u_{b})) Equation 6

In the example of Equation 6, hₛ^{k}(u_{b}) represents the vector output of a head network, k, for a strongly augmented (s) sample, u_{b}, of the unlabeled data 216. In the example of Equation 2, his' (u_{b}) can be defined as hₛ^{k}(u_{b})=f^{k}((g(Tₛ(u_{b})))) where f^{k}( ) represents a head network, go represents a feature encoder, and Tₛ( ) represents a strong augmentation operator.

In the illustrated example of FIG. 2, after determining the cross-entropy loss value and the unsupervised loss value for an AI model, the training control circuitry 204 adjusts model parameters (e.g., the model parameters 218) of the AI model based on the cross-entropy loss value and the unsupervised loss value. For example, the training control circuitry 204 determines a combination loss value based on a combination (e.g., a weighted sum) of the cross-entropy loss value and the unsupervised loss value. Additionally, for example, the training control circuitry 204 adjusts the model parameters to reduce (e.g., minimize) the combination loss value. The training control circuitry 204 controls training of an AI model for a threshold number of epochs known to be sufficient for the AI model to converge on a threshold amount of loss determined by a loss function. As used herein, an epoch refers to complete processing of training data by an AI model. For example, in the example of FIG. 2, the training control circuitry 204 controls training of an AI model for 204,800 inferences of the AI model to obtain state of the art accuracy. In some examples, the training control circuitry 204 implements the first training phase and the second training phase in parallel. Additionally, in some examples, the training control circuitry 204 is instantiated by programmable circuitry executing training control instructions and/or configured to perform operations such as those represented by the flowchart(s) of FIG. 6.

In some examples, the model training circuitry 102 includes means for controlling training. For example, the means for controlling training may be implemented by the training control circuitry 204. In some examples, the training control circuitry 204 may be instantiated by programmable circuitry such as the example programmable circuitry 812 of FIG. 8. For instance, the training control circuitry 204 may be instantiated by the example microprocessor 900 of FIG. 9 executing machine executable instructions such as those implemented by at least blocks 602, 604, 606, 612, 614, 616, 618, and 620 of FIG. 6. In some examples, the training control circuitry 204 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the training control circuitry 204 may be instantiated by any other combination of hardware, software, and/or firmware. For example, the training control circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 2, the feature encoder circuitry 206 is coupled to the training control circuitry 204 and the head network execution circuitry 208₁-208_{K}. In the example of FIG. 2, the feature encoder 206 implements a backbone network to encode one or more input samples into a feature vector for processing by the head network execution circuitry 208₁-208_{K}. For example, the feature encoder 206 implements one or more convolutional layers, one or more rectified linear unit (ReLU) layers, and/or one or more pooling layers to extract features from an input sample and encode the features into a feature vector. As described above, in examples equations disclosed herein, the feature encoder circuitry 206 may be represented as go. In some examples, the feature encoder circuitry 206 is instantiated by programmable circuitry executing feature encoding instructions and/or configured to perform operations such as those represented by the flowchart(s) of FIG. 6.

In some examples, the model training circuitry 102 includes means for encoding features. For example, the means for encoding features may be implemented by the feature encoder circuitry 206. In some examples, the feature encoder circuitry 206 may be instantiated by programmable circuitry such as the example programmable circuitry 812 of FIG. 8. For instance, the feature encoder circuitry 206 may be instantiated by the example microprocessor 900 of FIG. 9 executing machine executable instructions such as those implemented by at least blocks 602 and 614 of FIG. 6. In some examples, the feature encoder circuitry 206 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the feature encoder circuitry 206 may be instantiated by any other combination of hardware, software, and/or firmware. For example, the feature encoder circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 2, the head network execution circuitry 208₁-208_{K} is coupled to the feature encoder circuitry 206 and the datastore 212. While in the illustrated example the head network execution circuitry 208₁-208_{K} is illustrated as multiple instances of circuitry, the head network execution circuitry 208₁-208_{K} may be implemented by any number of instances of circuitry. In the example of FIG. 2, the head network execution circuitry 208₁-208_{K} implements one or more classifiers (e.g., semantic classifiers) to generate classifications for input samples.

In the illustrated example of FIG. 2, during training, the head network execution circuitry 208₁-208_{K} implements multiple head networks where respective head networks include multiple non-linear layers, an identity layer, an average operator, and an FC layer. For example, example first head network execution circuitry 208₁ implements a first head network (sometimes referred to as a single head) including multiple non-linear layers, an identity layer, an average operator, and an FC layer. In the example of FIG. 2, a non-linear layer of head network includes an FC layer and a BN layer. Example non-linear layers of head networks include an FC layer and a BN layer to allow for re-parameterizable classification head networks. In examples disclosed herein, an FC layer refers to a linear layer where every input neuron is connected to every output neuron. For example, if an FC layer includes two input neurons and two output neurons, then (1) a first input neuron is connected to a first output neuron and a second output neuron and (2) a second input neuron is connected to the first output neuron and the second output neuron. In examples disclosed herein, a BN layer refers to a non-linear layer that normalizes an input vector by fixing the mean and variance of the input vector.

In the illustrated example of FIG. 2, during deployment (e.g., inference), the head network execution circuitry 208₁-208_{K} implements a single FC layer. As described below, the structural reparameterization circuitry 210 re-parameterizes a portion of the model parameters 218 to re-parameterize the multiple head networks into a single FC layer. As such, the model architecture of an AI model changes depending on the phase of operation of the AI model. In the example of FIG. 2, by implementing non-linearity during training, the head network execution circuitry 208₁-208_{K} facilitates training AI models to learn more representative features of input samples than other techniques. In some examples, the head network execution circuitry 208₁-208_{K} is instantiated by programmable circuitry executing head network instructions and/or configured to perform operations such as those represented by the flowchart(s) of FIG. 6.

In some examples, the model training circuitry 102 includes means for executing head networks. For example, the means for executing head networks may be implemented by the head network execution circuitry 208₁-208_{K}. In some examples, the head network execution circuitry 208₁-208_{K} may be instantiated by programmable circuitry such as the example programmable circuitry 812 of FIG. 8. For instance, the head network execution circuitry 208₁-208_{K} may be instantiated by the example microprocessor 900 of FIG. 9 executing machine executable instructions such as those implemented by at least blocks 602, 608, 610, and 614 of FIG. 6. In some examples, the head network execution circuitry 208₁-208_{K} may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the head network execution circuitry 208₁-208_{K} may be instantiated by any other combination of hardware, software, and/or firmware. For example, the head network execution circuitry 208₁-208_{K} may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 2, the structural reparameterization circuitry 210 is coupled to the datastore 212. In the example of FIG. 2, the structural reparameterization circuitry 210 re-parameterizes the model parameters 218 to restructure the topology of the head network(s) executed by the head network execution circuitry 208₁-208_{K}. For example, the structural reparameterization circuitry 210 re-parameterizes a non-linear layer (e.g., an FC layer and a BN layer) into a single FC layer. A BN layer includes online parameters, μ_{B}^{(k)} and σ_{B}^{(k)}, and trainable parameters, γ^{(k)} and β^{(k)}, where μ_{B}^{(k)} represents the mean of a batch B, σ_{B}^{(k)} represents the variance of the batch B. During structural reparameterization, the structural reparameterization circuitry 210 replaces the online parameters with a running mean and a running standard deviation to convert the non-linear layer to an FC layer. Equation 7(a)-7(c) illustrate how the structural reparameterization circuitry 210 re-parameterizes a non-linear layer, \tilde{g}(e.g., an FC layer and a BN layer) into a single FC layer, \tilde{g}.

\tilde{g}=diag(γ)diag(\hat{σ})⁻¹((Wz+b)−\hat{μ})+β Equation 7(a)

\tilde{g}=diag(γ)diag(\hat{σ})⁻¹Wz+diag(γ)diag(\hat{σ})⁻¹(b−\hat{μ})+β Equation 7(b)=

\tilde{g}=W*z+13*β* Equation 7(c)

In Equations 7(a)-7(c), W represents a weight matrix of an FC layer (e.g., W∈ [symbol] ^{C×C}) b represents a bias vector of the FC layer (e.g., b∈ [symbol] ^{C}), and z represents an input vector to the FC layer where the input vector, z, includes a C-dimensional channel. Additionally, in Equations 7(a)-7(c), \hat{μ} (e.g., \hat{μ}∈ [symbol] ^{C}), & (e.g., \hat{σ}∈ [symbol] ^{C}), γ (e.g., γ∈ [symbol] ^{C}), and β(e.g., β∈ [symbol] ^{C}) represent running statistics and learnable parameters of a BN layer.

In the illustrated example of FIG. 2, the structural reparameterization circuitry 210 re-parameterizes an identity layer into an FC layer by defining a weight matrix for the FC layer as an identity matrix and by defining a bias vector for the FC layer as a zero vector. After re-parameterizing each non-linear layer of a head network into a first fully connected layer and the identity layer of the head network into a second fully connected layer, the structural reparameterization circuitry 210 re-parameterizes the multiple first fully connected layers, the second fully connected layer, the average operator, and the third fully connected layer of the head network into a single fully connected layer. Equations 8, 9, and 10 illustrate how the structural reparameterization circuitry 210 re-parameterizes multiple fully connected layers and an average operator into a single FC layer.

$$\frac{1}{n} {\sum }_{i = 1 , … , n} ( ) \qquad Equation 8$$

$${y}_{i} = {W}_{i} x + {b}_{i} , for i = 1 , … , n \qquad Equation 9$$

$$\frac{1}{n} {\sum }_{i = 1 , … , n} {y}_{i} = \frac{1}{n} {\sum }_{i = 1 , … , n} {W}_{i} x + {b}_{i} = ( \frac{1}{n} {\sum }_{i = 1 , … , n} {W}_{i} ) x + \frac{1}{n} {\sum }_{i = 1 , … , n} {b}_{i} , \qquad Equation 10$$

$$for i = 1 , … , n$$

Equation 8 represents the average operator for an input over n samples. Equation 9 represents n fully connected layers yᵢ having an input x with weights Wᵢ and biases bᵢ. Equation 10 converts the n fully connected layers yᵢ and the average operator

$$( \frac{1}{n} {Σ}_{i = 1 , … , n} ( ) )$$

to a linear operator for an input x. In the illustrated example of FIG. 2, after re-parameterizing the multiple head networks into multiple fully connected layers, the structural reparameterization circuitry 210 re-parameterizes the multiple fully connected layers and an average operator into a single fully connected layer. For example, the structural reparameterization circuitry 210 implements Equation 10. In this manner, the structural reparameterization circuitry 210 re-parameterizes the multiple head networks into a single fully connected layer. Example Pseudocode 1 to implement a head network (e.g., a single head) and multiple head networks (e.g., an ensemble head) is illustrated below. Example Pseudocode 1 is written in PyTorch. In some examples, the structural reparameterization circuitry 210 is instantiated by programmable circuitry executing structural reparameterization instructions and/or configured to perform operations such as those represented by the flowchart(s) of FIGS. 6 and/or 7.

Pseudocode 1

| | |
|---|---|
| 1 | import torch |
| 2 | from torch import nn |
| 3 | |
| 4 | class SingleHead(nn.Module): |
| 5 | def _{——}init_{——}(self, n_channels, n_classes, |
| | n_blocks): |
| 6 | self.bn_path = nn.ModuleList([ |
| 7 | nn.Sequential(nn.Linear(n_channels, |
| | n_channels), nn.BatchNorm1d( |
| | n_channels)) |
| 8 | for _ in range(n_blocks)]) |
| 9 | self.id_path = nn.Identity( ) |
| 10 | self.clf = nn.Linear(n_channels, |
| | n_classes) |
| 11 | |
| 12 | def forward(self, x): |
| 13 | y = self.id_path(x) |
| 14 | for bn_path in self.bn_path: |
| 15 | y = y + bn_path(x) |
| 16 | return self.clf(y) |
| 17 | |
| 18 | class EnsembleHead(nn.Module): |
| 19 | def _{——}init_{——}(self, n_channels, n_classes, |
| | n_ensembles, n_blocks): |
| 20 | self.heads = nn.ModuleList([ |
| 21 | SingleHead(n_channels, n_classes, |
| | n_blocks) for _ in range( |
| | n_ensembles)]) |
| 22 | |
| 23 | def forward(self, x): |
| 24 | return torch.stack([head(x) for head in |
| | self.heads], dim=1) |

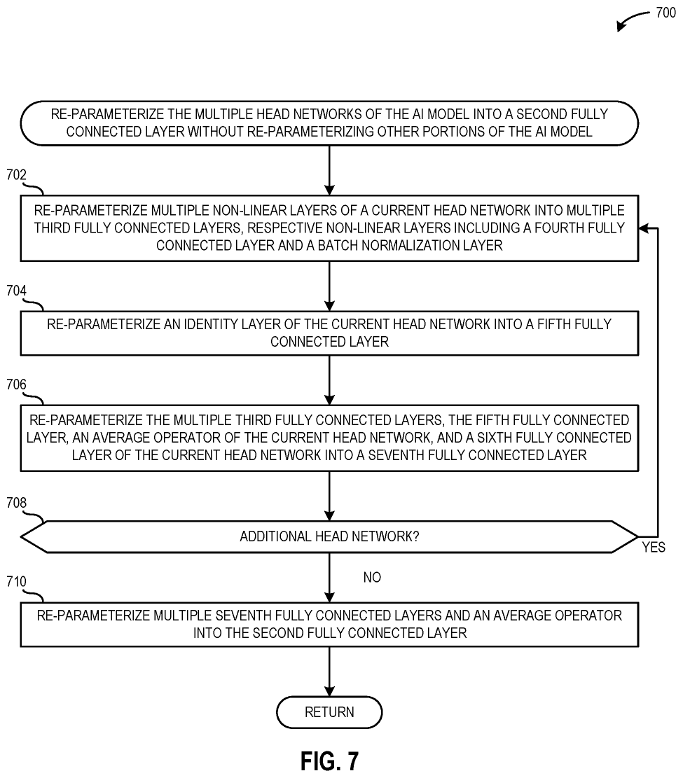

In some examples, the model training circuitry 102 includes means for re-parameterizing. For example, the means for re-parameterizing may be implemented by the structural reparameterization circuitry 210. In some examples, the structural reparameterization circuitry 210 may be instantiated by programmable circuitry such as the example programmable circuitry 812 of FIG. 8. For instance, the structural reparameterization circuitry 210 may be instantiated by the example microprocessor 900 of FIG. 9 executing machine executable instructions such as those implemented by at least block 622 of FIG. 6 and/or at least blocks 702, 704, 706, 708, and 710 of FIG. 7. In some examples, the structural reparameterization circuitry 210 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the structural reparameterization circuitry 210 may be instantiated by any other combination of hardware, software, and/or firmware. For example, the structural reparameterization circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 2, the datastore 212 is configured to store data. For example, the datastore 212 can store one or more files indicative of the labeled data 214, the unlabeled data 216, the model parameters 218, the pseudo-labeled data 220, and/or any other values related to one or more training phases and/or inference phases. In the example of FIG. 2, the datastore 212 may be implemented by a volatile memory (e.g., a Synchronous Dynamic Random-Access Memory (SDRAM), DRAM, RAMBUS Dynamic Random-Access Memory (RDRAM), etc.) and/or a non-volatile memory (e.g., flash memory). The example datastore 212 may additionally or alternatively be implemented by one or more double data rate (DDR) memories, such as DDR, DDR2, DDR3, DDR4, mobile DDR (mDDR), etc.

In additional or alternative examples, the example datastore 212 may be implemented by one or more mass storage devices such as hard disk drive(s), compact disk drive(s), digital versatile disk drive(s), solid-state disk drive(s), etc. While in the illustrated example the datastore 212 is illustrated as a single database, the datastore 212 may be implemented by any number and/or type(s) of databases. Furthermore, the data stored in the datastore 212 may be in any data format such as, for example, binary data, comma delimited data, tab delimited data, structured query language (SQL) structures, etc.

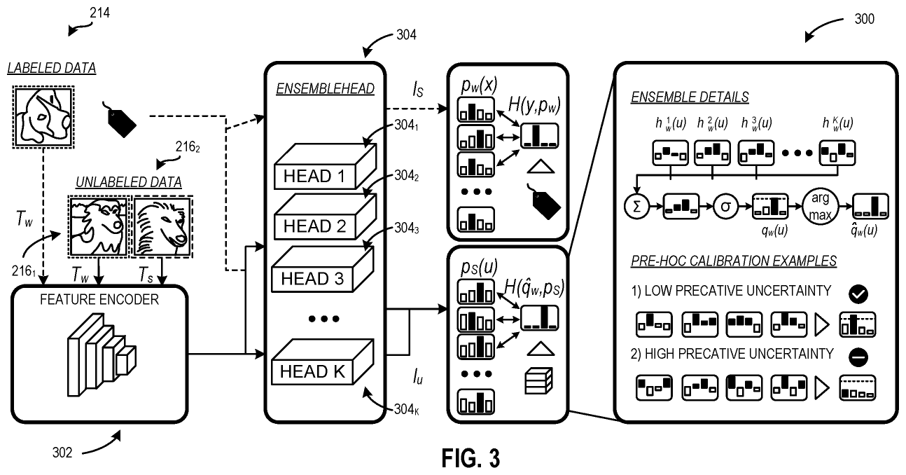

FIG. 3 is a block diagram of an example network architecture 300 of an example AI model implemented by the model training circuitry 102 of FIGS. 1 and/or 2 during training. In the example of FIG. 3, the network architecture 300 includes an example feature encoder 302 and an example ensemble head 304. In the example of FIG. 3, the ensemble head 304 includes K non-linear single heads (e.g., example single heads 304₁-304_{K}). In the example of FIG. 3, the feature encoder 302 is implemented by the feature encoder circuitry 206 of FIG. 2. In the example of FIG. 3, the ensemble head 304 is implemented by the head network execution circuitry 208₁-208_{K} of FIG. 2. For example, respective head network execution circuitry 208₁-208_{K} implements respective single heads 304₁-304_{K}.

In the illustrated example of FIG. 3, the feature encoder 302 processes samples of the labeled data 214 to generate feature vectors. For example, the feature encoder 302 processes a weakly augmented sample of the labeled data 214 to generate a first feature vector. Additionally, the example feature encoder 302 processes samples of the unlabeled data 216 to generate feature vectors. For example, the feature encoder 302 processes a weakly augmented version 2161 of a sample of the unlabeled data 216 to generate a second feature vectors. Additionally, for example, the feature encoder 302 processes a strongly augmented version 2162 of a sample of the unlabeled data 216 to generate a third feature vectors.

In the illustrated example of FIG. 3, the ensemble head 304 processes feature vectors generated by the feature encoder 302 to classify input data to the AI model. As described above, the ensemble head 304 may generate pseudo-labeled data (e.g., the pseudo-labeled data 220) to be used in training the AI model. Classifications generated by the ensemble head 304 are utilized to compute a cross-entropy loss value, Iₛ, and an unsupervised loss value, lᵤ, for the AI model. As described above, the training control circuitry 204 of FIG. 2 adjusts parameters of the AI model (e.g., the model parameters 218) to reduce the cross-entropy loss value, Iₛ, and the unsupervised loss value, lᵤ. As such, training the AI model with the ensemble head 304 allows for calibration of predictive uncertainty in SSL.

As illustrated in FIG. 3, the network architecture 300 implements ensembles in the head network without implementing ensembles for the backbone network (e.g., the feature encoder 302). By implementing ensembles only in the head network, the network architecture 300 implicitly reduces the computational cost of implementing SSL with the network architecture 300. For example, it is actually less feasible to implement ensembles for a whole network because SSL empirically requires more computation costs to achieve the improvements provided by ensembles than supervised training (e.g., wholly ensembled networks require almost 300 epochs to achieve improvements). Additionally, example single heads 304₁-304_{K} are non-linear operators. As such, examples disclosed herein increase the representation power of AI model(s) which increases model performance. Advantageously, as described below, by implementing structural reparameterization, examples disclosed herein avoid the complex architecture and performance degradation associated with non-linear layers during the deployment.

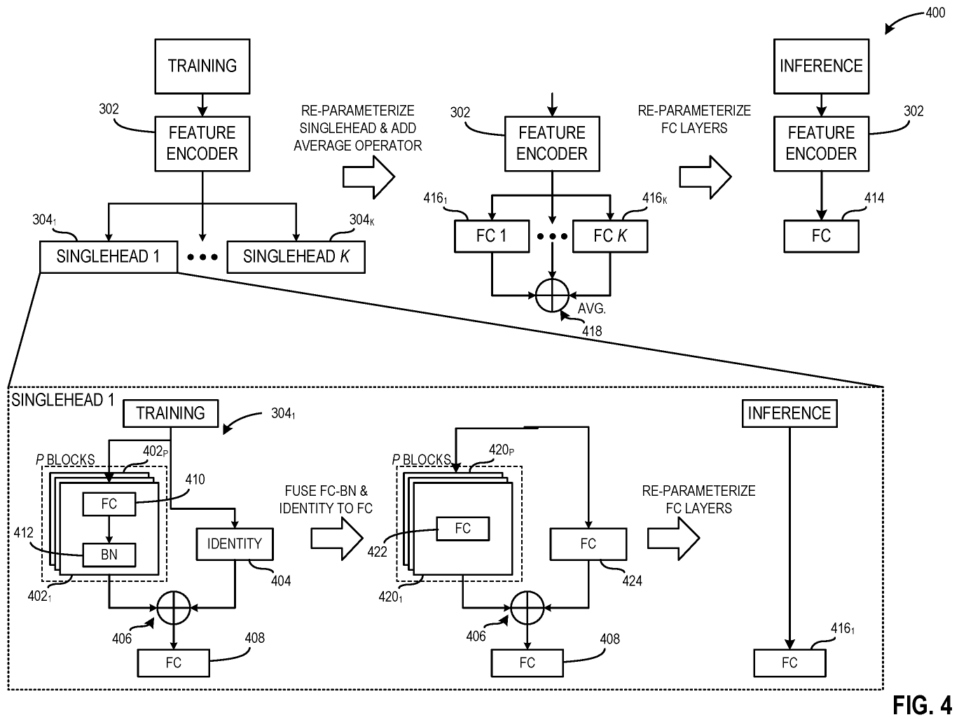

FIG. 4 is a flow diagram 400 illustrating example structural reparameterization implemented by the model training circuitry 102 of FIGS. 1 and/or 2. The flow diagram 400 illustrates example processes executed and/or instantiated by the structural reparameterization circuitry 210 of FIG. 2 to re-parameterize the ensemble head 304 (e.g., the single heads 304₁-304_{K} (e.g., non-linear layers)) into a single FC layer (e.g., a linear layer) at inference time. In the example of FIG. 4, at training time, a feature vector obtained from the feature encoder 302 is fed into the single heads 304₁-304_{K}.

In the illustrated example of FIG. 4, each of the single heads 304₁-304_{K} includes P non-linear layers, an identity layer, an average operator, and an FC layer. For example, an example first single head 304₁ includes example non-linear layers 402₁-402_{P}, an example identity layer 404, an example average operator 406, and an example FC layer 408. Each of the non-linear layers 402₁-402_{P} includes an FC layer and a BN layer. For example, an example first non-linear layer 402₁ includes an example FC layer 410 and an example BN layer 412.

In the illustrated example of FIG. 4, during training, the P non-linear layers (e.g., the non-linear layers 402₁-402_{P}) and the identity layer (e.g., the identity layer 404) of each of the single heads 304₁-304_{K} process, in parallel, a feature vector obtained from the feature encoder 302. The outputs of the P non-linear layers and the identity layer are combined by the average operator (e.g., the average operator 406) and processed by the FC layer (e.g., the FC layer 408) of each of the single heads 304₁-304_{K} to generate respective classifications for the single heads 304₁-304_{K}.

As described above, at inference time, the structural reparameterization circuitry 210 re-parameterizes the multiple head networks of an AI model into a single fully connected layer. In the example of FIG. 4, at inference time, the single heads 304₁-304_{K} are re-parameterized, by the structural reparameterization circuitry 210, into an example single FC layer 414. For example, the structural reparameterization circuitry 210 re-parameterizes the single heads 304₁-304_{K} into multiple example FC layers 416₁-416_{K} and combines the multiple FC layers 416₁-416_{K} via an example average operator 418. Subsequently, the structural reparameterization circuitry 210 re-parameterizes the multiple FC layers 416₁-416_{K} and the average operator 418 into the single FC layer 414.

In the illustrated example of FIG. 4, to re-parameterize the first single head 304₁ into an example first FC layer 416₁, the structural reparameterization circuitry 210 re-parameterizes the non-linear layers 402₁-402_{P} into example linear layers 420₁-420_{P}. For example, the structural reparameterization circuitry 210 implements Equations 7(a)-7(c) to re-parameterize the non-linear layers 402₁-402_{P} into the linear layers 420₁-420_{P}. In the example of FIG. 4, an example first linear layer 420₁ includes an example FC layer 422. The example structural reparameterization circuitry 210 also re-parameterizes the identity layer 404 into an example FC layer 424. Subsequently, the example structural reparameterization circuitry 210 re-parameterizes the linear layers 420₁— 420K (e.g., the multiple FC layers), the FC layer 424, the average operator 406, and the FC layer 408 into the first FC layer 416₁.

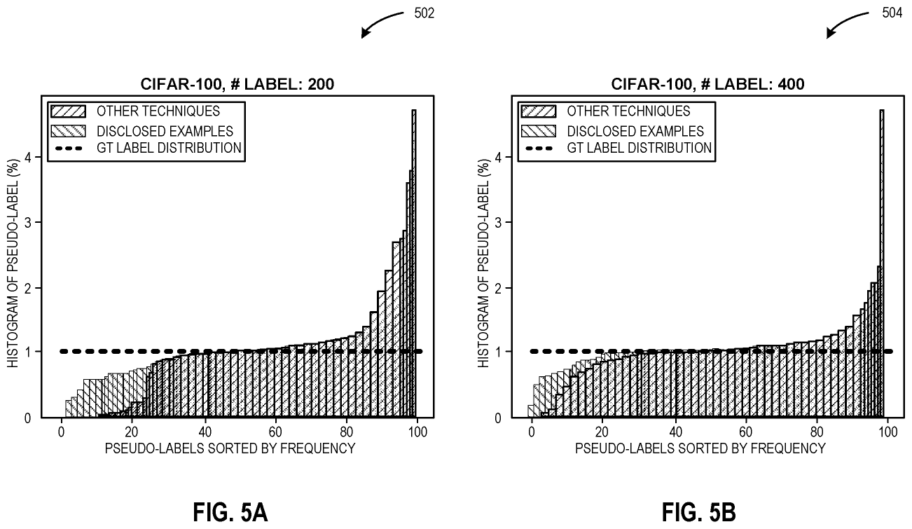

FIGS. 5A and 5B (referred to collectively as FIG. 5) illustrate graphical illustrations depicting example distributions of pseudo-labels achieved by examples disclosed herein. For example, FIG. 5A illustrates an example first graphical illustration 502 depicting example pseudo-label distribution achieved when training models according to examples disclosed herein with SSL on the CIFAR-100 dataset with 200 labeled samples, as compared to other techniques. The first graphical illustration 502 depicts pseudo-label distribution over class indices when feeding weakly augmented unlabeled data from the CIFAR-100 dataset. The performance of examples disclosed herein and other techniques can be verified with reference to the ground truth (GT) label distribution.

FIG. 5B illustrates an example second graphical illustration 504 depicting example pseudo-label distribution achieved when training models according to examples disclosed herein with SSL on the CIFAR-100 dataset with 400 labeled samples, as compared to other techniques. The second graphical illustration 504 depicts pseudo-label distribution over class indices when feeding weakly augmented unlabeled data from the CIFAR-100 dataset. The performance of examples disclosed herein and other techniques can be verified with reference to the GT label distribution.

Tables 1-3 illustrate further performance benefits achieved by examples disclosed herein. Table 1 illustrates unified SSL benchmark (USB) results for computer vision (CS) with the top-1 model accuracy when incorporating examples disclosed herein into FixMatch, AdaMatch, and SimMatch. All results are obtained by taking an average of over 3 seeds. USB results for CV may be referred to as USB-CV results.

TABLE 1

| | Dataset | | | | | | | | | |
|---|---|---|---|---|---|---|---|---|---|---|
| | CIFAR-100 | | STL-10 | | Euro-SAT | | TissueMNIST | | Semi-Aves | |
| Number of labeled data | 200 | 400 | 40 | 100 | 20 | 40 | 80 | 400 | 5959 | Average |
| FixMatch | 69.55 | 80.52 | 57.94 | 75.95 | 87.52 | 93.59 | 44.05 | 49.07 | 68.29 | 69.61 |
| FixMatch + | 73.83 | 81.39 | 65.15 | 78.88 | 91.48 | 95.02 | 42.56 | 47.86 | 68.42 | 71.62 |
| EnsembleHead | | | | | | | | | | |
| Gain | 4.28 | 0.87 | 7.21 | 2.93 | 3.96 | 1.43 | −1.49 | −1.21 | 0.16 | 2.02 |
| AdaMatch | 78.73 | 82.99 | 63.75 | 76.70 | 94.30 | 95.08 | 42.13 | 47.72 | 68.46 | 72.21 |
| AdaMatch + | 79.05 | 83.34 | 69.22 | 78.75 | 94.02 | 95.30 | 41.83 | 49.42 | 68.28 | 73.25 |
| EnsembleHead | | | | | | | | | | |
| Gain | 0.31 | 0.35 | 5.47 | 2.05 | −0.28 | 0.22 | −0.33 | 1.70 | −0.17 | 1.04 |
| SimMatch | 76.74 | 83.18 | 65.88 | 77.03 | 93.12 | 94.14 | 42.09 | 48.86 | 65.86 | 71.88 |
| SimMatch + | 76.88 | 83.09 | 68.33 | 79.23 | 94.55 | 95.20 | 41.74 | 48.18 | 66.28 | 72.61 |
| EnsembleHead | | | | | | | | | | |
| Gain | 0.14 | −0.09 | 2.45 | 2.20 | 1.43 | 1.07 | −0.35 | −0.68 | 0.42 | 0.73 |

Table 1 illustrates the accuracies of some SSL algorithms reported in USB-CV, the accuracies of those SSL algorithms when implementing examples disclosed herein (identified by +EnsembleHead), and the gains over baselines. USB-CV provides five CV datasets from different domains: CIFAR-100, STL-10, Euro-SAT, TissueMNIST, and Semi-Ayes. The gain, averaged across datasets, shows that examples disclosed herein provide AI models with an accuracy gain over other SSL algorithms. For example, examples disclosed herein provide a 2.02% accuracy gain over FixMatch, examples disclosed herein provide a 1.04% accuracy gain over AdaMatch, and examples disclosed herein provide a 0.73% accuracy gain over SimMatch.

Table 1 also illustrates that examples disclosed herein provide an additional model accuracy gain for the SSL algorithms equipped with the post-hoc calibration as examples disclosed herein are orthogonal to post-hoc calibration techniques. Table 2 illustrates experimental results in extremely low labeled data regimes where the number of labels per class is set to one for all datasets.

TABLE 2

| | Dataset | | | | | |
|---|---|---|---|---|---|---|
| | CIFAR-100 | STL-10 | Euro-SAT | TissueMNIST | Semi-Aves | |
| Number of labeled data | 100 | 10 | 10 | 8 | 200 | Average |
| FixMatch | 49.32 | 26.05 | 77.21 | 41.18 | 14.23 | 41.6 |
| FixMatch + | 55.43 | 31.79 | 81.73 | 39.32 | 15.13 | 44.68 |
| EnsembleHead | | | | | | |
| Gain | 6.12 | 5.74 | 4.52 | −1.86 | 0.9 | 3.08 |

Table 2 illustrates additional experiment results for datasets including extremely small labeled data. Unlike USB-CV, which includes at least two labeled data samples per class, Table 2 illustrates experimental results for classification on datasets including only one labeled data sample per class (e.g., a one-shot transfer case). Overall, examples disclosed herein (identified as EnsembleHead) provide a much larger gain compared to the original USB-CV benchmark in the extremely small labeled data regime. For all datasets except TissueMNIST, the accuracy gains achieved by incorporating examples disclosed herein are greater in the extremely small labeled data regime. As such, examples disclosed herein improve the quality of unsupervised learning. Table 3 illustrates experimental results when incorporating examples disclosed herein (identified as EnsembleHead) into FixMatch on the CIFAR-90-M dataset and the Euro-SAT-9-M dataset, where the CIFAR-90-M dataset and the Euro-SAT-9-M dataset are artificially generated to simulate the class distribution mismatch like the STL-10 dataset.

TABLE 3

| | | |
|---|---|---|
| Dataset | CIFAR-90-M | Euro-SAT-9-M |

| | | | | |
|---|---|---|---|---|
| Number of | 180 | 360 | 18 | 36 |
| labeled data | | | | |
| FixMatch | 72.65 | 81.55 | 93.25 | 95.53 |
| FixMatch + | 75.82 | 84.22 | 95.31 | 96.98 |
| EnsembleHead | | | | |
| Gain | 3.17 | 2.67 | 2.06 | 1.45 |

Table 3 illustrates that examples disclosed herein provide an accuracy gain on all class distributional mismatched datasets. Class distributional mismatched datasets are more common in the practical uses of SSL because matching class distribution between labeled and unlabeled data requires paying data cleansing costs additionally. In Table 3, the CIFAR-90-M dataset and the Euro-SAT-9-M dataset are synthesized from the CIFAR-100 dataset and the Euro-SAT dataset, respectively to simulate class distributional mismatched datasets. In Table 3, the labeled data of the CIFAR-90-M dataset is prepared with 90 classes randomly chosen from the CIFAR-100 dataset and the other 10 classes of the CIFAR-100 dataset are only included in the unlabeled data. Additionally, in Table 3, the labeled data of the Euro-SAT-9-M dataset is prepared by randomly choosing 9 out of 10 classes of the Euro-SAT data for labeled data. In both the CIFAR-90-M dataset and the Euro-SAT-9 dataset as well as in data settings including a different number of labeled data, examples disclosed herein provide more than 1.45% model accuracy gains.

While an example manner of implementing the model training circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example interface circuitry 202, the example training control circuitry 204, the example feature encoder circuitry 206, the example head network execution circuitry 208₁-208_{K}, the example structural reparameterization circuitry 210, and/or, more generally, the example model training circuitry 102 of FIG. 2, may be implemented by hardware alone or by hardware in combination with software and/or firmware. Thus, for example, any of the example interface circuitry 202, the example training control circuitry 204, the example feature encoder circuitry 206, the example head network execution circuitry 208₁-208_{K}, the example structural reparameterization circuitry 210, and/or, more generally, the example model training circuitry 102 of FIG. 2, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processor unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example model training circuitry 102 of FIG. 2 may include one or more elements, processes, and/or devices in addition to, or instead of, those illustrated in FIG. 2, and/or may include more than one of any or all of the illustrated elements, processes, and devices.

Flowchart(s) representative of example machine readable instructions, which may be executed by programmable circuitry (e.g., instructions to cause programmable circuitry) to implement and/or instantiate the model training circuitry 102 of FIG. 2 and/or representative of example operations which may be performed by programmable circuitry to implement and/or instantiate the model training circuitry 102 of FIG. 2, are shown in FIGS. 6 and/or 7. The machine readable instructions may be one or more executable programs or portion(s) of one or more executable programs for execution by programmable circuitry such as the programmable circuitry 812 shown in the example programmable circuitry platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6 and/or 7, many other methods of implementing the example model training circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 6 and/or 7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed, instantiated, and/or performed by programmable circuitry to implement the model training circuitry 102 of FIGS. 1 and/or 2. The example machine-readable instructions and/or the example operations 600 of FIG. 6 begin at block 602, at which the training control circuitry 204 trains an AI model using weakly augmented labeled data. In the example of FIG. 6, the AI model includes multiple head networks where respective head networks include multiple non-linear layers, an identity layer, an average operator, and a first fully connected layer.

In the illustrated example of FIG. 6, to train the AI model at block 602, the training control circuitry 204 processes labeled data (e.g., the labeled data 214) to generate weakly augmented labeled data. Additionally, at block 602, the training control circuitry 204 outputs samples of the weakly augmented labeled data to the feature encoder circuitry 206. At block 602, the feature encoder circuitry 206 generates a feature vector for a sample of weakly augmented labeled data and the head network execution circuitry 208₁-208_{K} processes the feature vector to generate one or more classifications for the sample of weakly augmented labeled data.

In the illustrated example of FIG. 6, at block 604, the training control circuitry 204 determines whether there is an additional sample of weakly augmented labeled data. Based on (e.g., in response to) the training control circuitry 204 determining that there is an additional sample of weakly augmented labeled data (block 604: YES), the machine-readable instructions and/or the operations 600 return to block 602. Based on (e.g., in response to) the training control circuitry 204 determining that there is not an additional sample of weakly augmented labeled data (block 604: NO), the machine-readable instructions and/or the operations 600 proceed to block 606.

In the illustrated example of FIG. 6, at block 606, the training control circuitry 204 determines a cross-entropy loss value for the AI model on (e.g., when processing) the weakly augmented labeled data. For example, at block 606, the training control circuitry 204 implements Equation 1 as described above. At block 608, the head network execution circuitry 208₁-208_{K} generates a first pseudo-label for a weakly augmented version of a sample of unlabeled data (e.g., the unlabeled data 216). For example, the training control circuitry 204 generates a weakly augmented version of a sample of unlabeled data and forwards the weakly augmented version of the sample to the feature encoder circuitry 206 to generate a feature vector. In such examples, the head network execution circuitry 208₁-208_{K}, at block 608, generates, with the AI model (e.g., the multiple head networks), a first pseudo-label for the weakly augmented version of the sample.

In the illustrated example of FIG. 6, at block 610, the head network execution circuitry 208₁-208_{K} generates a second pseudo-label for a strongly augmented version of the sample of unlabeled data (e.g., the unlabeled data 216). For example, the training control circuitry 204 generates a strongly augmented version of the sample of unlabeled data and forwards the strongly augmented version of the sample to the feature encoder circuitry 206 to generate a feature vector. In such examples, the head network execution circuitry 208₁-208_{K}, at block 610, generates, with the AI model (e.g., the multiple head networks), a second pseudo-label for the strongly augmented version of the sample.

In the illustrated example of FIG. 6, at block 612, the training control circuitry 204 determines whether there is an additional sample of unlabeled data. Based on (e.g., in response to) the training control circuitry 204 determining that there is an additional sample of unlabeled data (block 612: YES), the machine-readable instructions and/or the operations 600 return to block 608. Based on (e.g., in response to) the training control circuitry 204 determining that there is not an additional sample of unlabeled data (block 612: NO), the machine-readable instructions and/or the operations 600 proceed to block 614. In this manner, the AI model (e.g., the feature encoder circuitry 206 and the head network execution circuitry 208₁-208_{K}) generate pseudo-labeled data (e.g., the pseudo-labeled data 220).

In the illustrated example of FIG. 6, at block 614, the training control circuitry 204 trains the AI model using the labeled data (e.g., the labeled data 214) and the pseudo-labeled data (e.g., the pseudo-labeled data 220). For example, to train the AI model at block 614, the training control circuitry 204 outputs samples of the labeled data (e.g., the labeled data 214) and the pseudo-labeled data (e.g., the pseudo-labeled data 220) to the feature encoder circuitry 206. At block 614, the feature encoder circuitry 206 generates a feature vector for a sample of data (e.g., the labeled data 214 and/or the pseudo-labeled data 220) and the head network execution circuitry 208₁-208_{K} processes the feature vector to generate one or more classifications for the sample of data. At block 614, the AI model may be a different version of the AI model as compared to the AI model at block 602. For example, at block 614, the model parameters (e.g., the model parameters 218) of the AI model are updated by the training performed at block 602.

In the illustrated example of FIG. 6, at block 616, the training control circuitry 204 determines an unsupervised loss value for the AI model on (e.g., when processing) the labeled data and the pseudo-labeled data. For example, at block 616, the training control circuitry 204 implements Equation 3 as described above. At block 618, the training control circuitry 204 adjusts parameters of the AI model based on the cross-entropy loss value and the unsupervised loss value. For example, the training control circuitry 204 adjusts parameters of the AI model using stochastic gradient descent. However, any other training algorithm may additionally or alternatively be used. In the example of FIG. 6, at block 618, the training control circuitry 204 adjusts the model parameters 218, via stochastic gradient descent, based on the cross-entropy loss value determined at block 606 and the unsupervised loss value determined at block 616.

In the illustrated example of FIG. 6, at block 620, the training control circuitry 204 determines whether the AI model has been trained for a threshold number of epochs. Based on (e.g., in response to) the training control circuitry 204 determining that the AI model has not been trained for the threshold number of epochs (block 620: NO), the machine-readable instructions and/or the operations 600 return to block 602. Based on (e.g., in response to) the training control circuitry 204 determining that the AI model has been trained for the threshold number of epochs (block 620: YES), the machine-readable instructions and/or the operations 600 proceed to block 622.

In the illustrated example of FIG. 6, at block 622, the structural reparameterization circuitry 210 re-parameterizes the multiple head networks of the AI model into a second fully connected layer without re-parameterizing other portions (e.g., the backbone network) of the AI model. Example machine readable instructions and/or example operations that may be executed, instantiated, and/or performed by programmable circuitry to implement block 622 are illustrated and described in connection with FIG. 7. At block 624, the interface circuitry 202 deploys the AI model after reparameterization. For example, the interface circuitry 202 deploys the AI model for use as an executable construct that processes an input and provides an output based on the network of nodes and connections defined in the model. The AI model is stored at an endpoint device (e.g., the endpoint device 106). The AI model may then be executed by the endpoint device. In some examples, the model training circuitry 102 executes the AI model during training and inference time.

FIG. 7 is a flowchart representative of example machine readable instructions and/or example operations 700 that may be executed, instantiated, and/or performed by programmable circuitry to implement the model training circuitry 102 of FIGS. 1 and/or 2 to perform structural reparameterization. As described above, example AI models include multiple head networks where respective head networks include multiple non-linear layers, an identity layer, an average operator, and a first fully connected layer. The example machine readable instructions and/or the example operations 700 may be executed, instantiated, and/or performed to implement block 622 of the machine-readable instructions and/or the operations 600. As described above, at block 622, the structural reparameterization circuitry 210 re-parameterizes the multiple head networks of the AI model into a second fully connected layer without re-parameterizing other portions of the AI model.

In the illustrated example of FIG. 7, the example machine-readable instructions and/or the example operations 700 of FIG. 7 begin at block 702, at which the structural reparameterization circuitry 210 re-parameterizes multiple non-linear layers of a current head network into multiple third fully connected layers where respective non-linear layers include a fourth fully connected layer and a batch normalization layer. For example, at block 702, the structural reparameterization circuitry 210 implements Equations 7(a)-7(c). At block 704, the structural reparameterization circuitry 210 re-parameterizes an identity layer of the current head network into a fifth fully connected layer. For example, at block 704, the structural reparameterization circuitry 210 defines a weight matrix for the fifth fully connected layer as an identity matrix and defines a bias vector for the fifth fully connected layer as a zero vector.

In the illustrated example of FIG. 7, at block 706, the structural reparameterization circuitry 210 re-parameterizes the multiple third fully connected layers, the fifth fully connected layer, an average operator of the current head network, and a sixth fully connected layer of the current head network into a seventh fully connected layer. At block 708, the structural reparameterization circuitry 210 determines whether there is an additional head network. Based on (e.g., in response to) the structural reparameterization circuitry 210 determining that there is an additional head network (block 708: YES), the machine-readable instructions and/or the operations 700 return to block 702.

In the illustrated example of FIG. 7, based on (e.g., in response to) the structural reparameterization circuitry 210 determining that there is not an additional head network (block 708: NO), the machine-readable instructions and/or the operations 700 proceed to block 710. At block 710, the structural reparameterization circuitry 210 re-parameterizes multiple seventh fully connected layers and an average operator into the second fully connected layer. After block 710, the machine-readable instructions and/or the operations 700 return to the machine-readable instructions and/or the operations 600 at block 624.

FIG. 8 is a block diagram of an example programmable circuitry platform 800 structured to execute and/or instantiate the example machine-readable instructions and/or the example operations of FIGS. 6 and/or 7 to implement the model training circuitry 102 of FIGS. 1 and/or 2. The programmable circuitry platform 800 can be, for example, a server, a personal computer, a workstation, a self-learning machine (e.g., a neural network), a mobile device (e.g., a cell phone, a smart phone, a tablet such as an iPad′), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example training control circuitry 204, the example feature encoder circuitry 206, the example head network execution circuitry 208₁-208_{K}, and the example structural reparameterization circuitry 210.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In this example, the interface circuitry 820 implements the example interface circuitry 202.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In this example, the one or more mass storage discs or devices 828 implement the datastore 212. As described above, the datastore 212 may include the labeled data 214, the unlabeled data 216, the model parameters 218, and the pseudo-labeled data 220.

The machine readable instructions 832, which may be implemented by the machine readable instructions of FIGS. 6 and/or 7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 6 and/or 7 to effectively instantiate the circuitry of FIG. 2 as logic circuits to perform operations corresponding to those machine readable instructions. In some such examples, the circuitry of FIG. 2 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 6 and/or 7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry 916 (sometimes referred to as an ALU), a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIGS. 6 and/or 7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 6 and/or 7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6 and/or 7. As such, the FPGA circuitry 1000 may be configured and/or structured to effectively instantiate some or all of the operations/functions corresponding to the machine readable instructions of the flowchart(s) of FIGS. 6 and/or 7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 6 and/or 7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 6 and/or 7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 10. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIGS. 6 and/or 7 to perform first operation(s)/function(s), the FPGA circuitry 1000 of FIG. 10 may be configured and/or structured to perform second operation(s)/function(s) corresponding to a second portion of the machine readable instructions represented by the flowcharts of FIGS. 6 and/or 7, and/or an ASIC may be configured and/or structured to perform third operation(s)/function(s) corresponding to a third portion of the machine readable instructions represented by the flowcharts of FIGS. 6 and/or 7.

It should be understood that some or all of the circuitry of FIG. 2 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 2 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

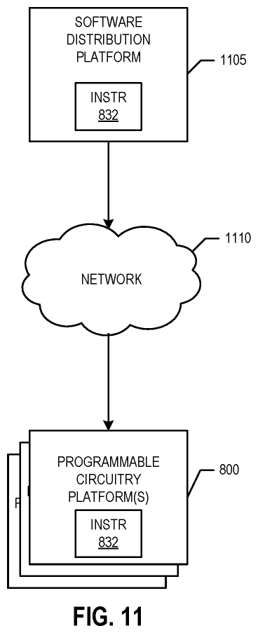

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 6 and/or 7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIGS. 6 and/or 7, may be downloaded to the example programmable circuitry platform 800, which is to execute the machine readable instructions 832 to implement the model training circuitry 102. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that re-parameterize multiple head networks of an artificial intelligence model into a single fully connected layer. Additionally, example systems, apparatus, articles of manufacture, and methods have been disclosed that improve (e.g., enhance) the calibration of predictive uncertainty through deep ensembles and structural reparameterization so that model training is leveraged by high-confident samples (e.g., through Equation 3). Furthermore, examples disclosed herein exploit ensembles of non-linear paths at training time, but at inference time, examples disclosed herein transform (e.g., via structural reparameterization) the non-linear paths into a single linear classifier. Disclosed systems, apparatus, articles of manufacture, and methods improve the efficiency of using a computing device by improving classification accuracy of an AI model through the use of non-linear layers at training time and re-parameterizing the non-linear layers at inference time to reduce the computational burden of implementing the AI model. Disclosed systems, apparatus, articles of manufacture, and methods are accordingly directed to one or more improvement(s) in the operation of a machine such as a computer or other electronic and/or mechanical device.

Disclosed pre-hoc calibration for SSL can applied to any SSL algorithm. Example systems, apparatus, articles of manufacture, and methods disclosed herein achieve state-of-the-art performance on SSL. Examples disclosed herein can also be applied to supervised learning and/or unsupervised learning. Additionally, examples disclosed herein alter training cost by negligible amounts and do not increase computational cost during deployment. Examples disclosed herein can be implemented in computer vision platforms to allow end-users to build high-quality vision AI models when large amounts of labeled data is not available.

Example methods, apparatus, systems, and articles of manufacture to re-parameterize multiple head networks of an artificial intelligence model are disclosed herein. Further examples and combinations thereof include the following:

Example 1 includes an apparatus to re-parameterize multiple head networks of an artificial intelligence (AI) model, the apparatus comprising interface circuitry, machine readable instructions, and programmable circuitry to at least one of instantiate or execute the machine readable instructions to train an AI model using labeled data and pseudo-labeled data, the AI model including multiple head networks, and after the AI model has been trained, re-parameterize the multiple head networks of the AI model into a fully connected layer without re-parameterizing other portions of the AI model.

Example 2 includes the apparatus of example 1, wherein the programmable circuitry is to generate, with the AI model, the pseudo-labeled data by classifying unlabeled data with the multiple head networks.

Example 3 includes the apparatus of any of examples 1 or 2, wherein the programmable circuitry is to re-parameterize the multiple head networks into multiple fully connected layers, and re-parameterize the multiple fully connected layers and an average operator into the fully connected layer.

Example 4 includes the apparatus of any of examples 1, 2, or 3, wherein the fully connected layer is a first fully connected layer, respective head networks of the multiple head networks include multiple non-linear layers, an identity layer, an average operator, and a second fully connected layer, and respective non-linear layers of the multiple non-linear layers include a third fully connected layer and a batch normalization layer.

Example 5 includes the apparatus of example 4, wherein to re-parameterize the respective head networks of the multiple head networks, the programmable circuitry is to re-parameterize the multiple non-linear layers of the respective head networks into multiple fully connected layers, re-parameterize the identity layer of the respective head networks into a fourth fully connected layer, and re-parameterize the multiple fully connected layers, the fourth fully connected layer, the average operator, and the second fully connected layer into a fifth fully connected layer.

Example 6 includes the apparatus of example 5, wherein to re-parameterize the identity layer of the respective head networks into the fourth fully connected layer, the programmable circuitry is to define a weight matrix and a bias vector for the fourth fully connected layer, the weight matrix including an identity matrix, the bias vector including a zero vector.

Example 7 includes the apparatus of any of examples 1, 2, 3, or 4, wherein the programmable circuitry is to determine whether the AI model has been trained for a threshold number of epochs.

Example 8 includes a non-transitory machine readable storage medium comprising instructions to cause programmable circuitry to at least train an artificial intelligence (AI) model using labeled data and pseudo-labeled data, the AI model including multiple head networks, and after the AI model has been trained, re-parameterize the multiple head networks of the AI model into a fully connected layer without re-parameterizing other portions of the AI model.

Example 9 includes the non-transitory machine readable storage medium of example 8, wherein the instructions cause the programmable circuitry to generate the pseudo-labeled data by classifying unlabeled data with the multiple head networks.

Example 10 includes the non-transitory machine readable storage medium of any of examples 8 or 9, wherein the instructions cause the programmable circuitry to re-parameterize the multiple head networks into multiple fully connected layers, and re-parameterize the multiple fully connected layers and an average operator into the fully connected layer.

Example 11 includes the non-transitory machine readable storage medium of any of examples 8, 9, or 10, wherein the fully connected layer is a first fully connected layer, respective head networks of the multiple head networks include multiple non-linear layers, an identity layer, an average operator, and a second fully connected layer, and respective non-linear layers of the multiple non-linear layers include a third fully connected layer and a batch normalization layer.

Example 12 includes the non-transitory machine readable storage medium of example 11, wherein to re-parameterize the respective head networks of the multiple head networks, the instructions cause the programmable circuitry to re-parameterize the multiple non-linear layers of the respective head networks into multiple fully connected layers, re-parameterize the identity layer of the respective head networks into a fourth fully connected layer, and re-parameterize the multiple fully connected layers, the fourth fully connected layer, the average operator, and the second fully connected layer into a fifth fully connected layer.

Example 13 includes the non-transitory machine readable storage medium of example 12, wherein to re-parameterize the identity layer of the respective head networks into the fourth fully connected layer, the instructions cause the programmable circuitry to define a weight matrix and a bias vector for the fourth fully connected layer, the weight matrix including an identity matrix, the bias vector including a zero vector.

Example 14 includes the non-transitory machine readable storage medium of any of examples 8, 9, 10, or 11, wherein the instructions cause the programmable circuitry to determine whether the AI model has been trained for a threshold number of epochs.

Example 15 includes a method to re-parameterize multiple head networks of an artificial intelligence (AI) model, the method comprising training, by executing an instruction with programmable circuitry, the AI model using labeled data and pseudo-labeled data, the AI model including multiple head networks, and after the AI model has been trained, re-parameterizing, by executing an instruction with the programmable circuitry, the multiple head networks of the AI model into a fully connected layer without re-parameterizing other portions of the AI model.

Example 16 includes the method of example 15, further including generating, with the AI model, the pseudo-labeled data by classifying unlabeled data with the multiple head networks.

Example 17 includes the method of any of examples 15 or 16, further including re-parameterizing the multiple head networks into multiple fully connected layers, and re-parameterizing the multiple fully connected layers and an average operator into the fully connected layer.

Example 18 includes the method of any of examples 15, 16, or 17, wherein the fully connected layer is a first fully connected layer, respective head networks of the multiple head networks include multiple non-linear layers, an identity layer, an average operator, and a second fully connected layer, and respective non-linear layers of the multiple non-linear layers include a third fully connected layer and a batch normalization layer.

Example 19 includes the method of example 18, further including re-parameterizing the respective head networks of the multiple head networks by re-parameterizing the multiple non-linear layers of the respective head networks into multiple fully connected layers, re-parameterizing the identity layer of the respective head networks into a fourth fully connected layer, and re-parameterizing the multiple fully connected layers, the fourth fully connected layer, the average operator, and the second fully connected layer into a fifth fully connected layer.

Example 20 includes the method of example 19, further including re-parameterizing the identity layer of the respective head networks into the fourth fully connected layer by defining a weight matrix and a bias vector for the fourth fully connected layer, the weight matrix including an identity matrix, the bias vector including a zero vector.

Example 21 includes the method of any of examples 15, 16, 17, or 18, further including determining whether the AI model has been trained for a threshold number of epochs.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus to re-parameterize multiple head networks of an artificial intelligence (AI) model, the apparatus comprising:
interface circuitry;
machine readable instructions; and
programmable circuitry to at least one of instantiate or execute the machine readable instructions to:
train an AI model using labeled data and pseudo-labeled data, the AI model including multiple head networks; and
after the AI model has been trained, re-parameterize the multiple head networks of the AI model into a fully connected layer without re-parameterizing other portions of the AI model.

2. The apparatus of claim 1, wherein the programmable circuitry is to generate, with the AI model, the pseudo-labeled data by classifying unlabeled data with the multiple head networks.

3. The apparatus of claim 1, wherein the programmable circuitry is to:
re-parameterize the multiple head networks into multiple fully connected layers; and
re-parameterize the multiple fully connected layers and an average operator into the fully connected layer.

4. The apparatus of claim 1, wherein:
the fully connected layer is a first fully connected layer;
respective head networks of the multiple head networks include multiple non-linear layers, an identity layer, an average operator, and a second fully connected layer; and
respective non-linear layers of the multiple non-linear layers include a third fully connected layer and a batch normalization layer.

5. The apparatus of claim 4, wherein to re-parameterize the respective head networks of the multiple head networks, the programmable circuitry is to:
re-parameterize the multiple non-linear layers of the respective head networks into multiple fully connected layers;
re-parameterize the identity layer of the respective head networks into a fourth fully connected layer; and
re-parameterize the multiple fully connected layers, the fourth fully connected layer, the average operator, and the second fully connected layer into a fifth fully connected layer.

6. The apparatus of claim 5, wherein to re-parameterize the identity layer of the respective head networks into the fourth fully connected layer, the programmable circuitry is to define a weight matrix and a bias vector for the fourth fully connected layer, the weight matrix including an identity matrix, the bias vector including a zero vector.

7. The apparatus of claim 1, wherein the programmable circuitry is to determine whether the AI model has been trained for a threshold number of epochs.

8. A non-transitory machine readable storage medium comprising instructions to cause programmable circuitry to at least:
train an artificial intelligence (AI) model using labeled data and pseudo-labeled data, the AI model including multiple head networks; and
after the AI model has been trained, re-parameterize the multiple head networks of the AI model into a fully connected layer without re-parameterizing other portions of the AI model.

9. The non-transitory machine readable storage medium of claim 8, wherein the instructions cause the programmable circuitry to generate the pseudo-labeled data by classifying unlabeled data with the multiple head networks.

10. The non-transitory machine readable storage medium of claim 8, wherein the instructions cause the programmable circuitry to:
re-parameterize the multiple head networks into multiple fully connected layers; and
re-parameterize the multiple fully connected layers and an average operator into the fully connected layer.

11. The non-transitory machine readable storage medium of claim 8, wherein:
the fully connected layer is a first fully connected layer;
respective head networks of the multiple head networks include multiple non-linear layers, an identity layer, an average operator, and a second fully connected layer; and
respective non-linear layers of the multiple non-linear layers include a third fully connected layer and a batch normalization layer.

12. The non-transitory machine readable storage medium of claim 11, wherein to re-parameterize the respective head networks of the multiple head networks, the instructions cause the programmable circuitry to:
re-parameterize the multiple non-linear layers of the respective head networks into multiple fully connected layers;
re-parameterize the identity layer of the respective head networks into a fourth fully connected layer; and
re-parameterize the multiple fully connected layers, the fourth fully connected layer, the average operator, and the second fully connected layer into a fifth fully connected layer.

13. The non-transitory machine readable storage medium of claim 12, wherein to re-parameterize the identity layer of the respective head networks into the fourth fully connected layer, the instructions cause the programmable circuitry to define a weight matrix and a bias vector for the fourth fully connected layer, the weight matrix including an identity matrix, the bias vector including a zero vector.

14. The non-transitory machine readable storage medium of claim 8, wherein the instructions cause the programmable circuitry to determine whether the AI model has been trained for a threshold number of epochs.

15. A method to re-parameterize multiple head networks of an artificial intelligence (AI) model, the method comprising:
training, by executing an instruction with programmable circuitry, the AI model using labeled data and pseudo-labeled data, the AI model including multiple head networks; and
after the AI model has been trained, re-parameterizing, by executing an instruction with the programmable circuitry, the multiple head networks of the AI model into a fully connected layer without re-parameterizing other portions of the AI model.

16. The method of claim 15, further including generating, with the AI model, the pseudo-labeled data by classifying unlabeled data with the multiple head networks.

17. The method of claim 15, further including:
re-parameterizing the multiple head networks into multiple fully connected layers; and
re-parameterizing the multiple fully connected layers and an average operator into the fully connected layer.

18. The method of claim 15, wherein:
the fully connected layer is a first fully connected layer;
respective head networks of the multiple head networks include multiple non-linear layers, an identity layer, an average operator, and a second fully connected layer; and
respective non-linear layers of the multiple non-linear layers include a third fully connected layer and a batch normalization layer.

19. The method of claim 18, further including re-parameterizing the respective head networks of the multiple head networks by:
re-parameterizing the multiple non-linear layers of the respective head networks into multiple fully connected layers;
re-parameterizing the identity layer of the respective head networks into a fourth fully connected layer; and
re-parameterizing the multiple fully connected layers, the fourth fully connected layer, the average operator, and the second fully connected layer into a fifth fully connected layer.

20. The method of claim 19, further including re-parameterizing the identity layer of the respective head networks into the fourth fully connected layer by defining a weight matrix and a bias vector for the fourth fully connected layer, the weight matrix including an identity matrix, the bias vector including a zero vector.

21. (canceled)
